(19) United States
(12) Patent Application Publication
(10) Pub. No.: US 2007/0060220 A1
(43) Pub. Date: Mar. 15, 2007

(54) Gliding structure for glide-open type mobile phone

(76) Inventor: An-Szu Hsu, Shulin City (TW)

Correspondence Address: HDSL, 4331 STEVENS BATTLE LANE, FAIRFAX, VA, 22033, US

(21) Appl. No.: 11/225,080

(22) Filed: Sep. 14, 2005

(51) Int. Cl. H04M 1/00

(52) U.S. Cl. 455/575.4

(57) ABSTRACT

A gliding structure is arranged between a case and an envelope of a mobile phone. The gliding structure includes a bottom plate member, an upper cap and an elastic member. The bottom plate member includes a guiding section and a turning section on inner side of the guiding section. The upper cap includes a sliding section and a directing section. The sliding section is slidably fit with the guiding section and the directing section is arranged corresponding to the turning section. The directing section is moved in a direction non-parallel to a direction of the sliding section. The elastic member is arranged between the bottom plate member and the upper cap and includes two ends connected to the bottom plate member and slidable within the directing section, respectively. Therefore, the envelope of the mobile phone has smooth turning and has ideal opening and closing operability.

### BACKGROUND OF THE INVENTION

1. Field of the Invention

The present invention relates to an improved gliding structure for a glide-open type mobile phone, especially to an improved gliding structure for the glide-open type mobile phone whose envelope has smooth turning and has ideal opening and closing operability.

2. Description of Related Art

The mobile phones are prevailing personal mobile communication tools. More particular, the glide-open type mobile phones with single hand operability are most attractive to user. However, the glide-open type mobile phones have the problem of non-smooth sliding operation. Therefore, the gliding structure for the glide-open type mobile phones is important design issue.

Taiwan Patent Application No. 93202823 discloses a gliding structure for the glide-open type mobile phone. The gliding structure comprises a bottom plate, an upper cap and a spring. The bottom plate comprises sliding rails and a plurality of fixing holes on both sides thereof. The upper cap comprises, rails on both sides thereof, a plurality of fixing holes and sliding grooves engagable with the sliding rails. The spring is provided between the a bottom plate and the upper cap with one end pivotally arranged on lateral side of the bottom plate and another end pivotally arranged on corresponding lateral side of the upper cap. When the cover of the mobile phone is pushed downward, the upper cap is moved upward such that the deformation amount of the spring exceeds critical point for turning change. The cover is further moved downward by the elastic force of the spring and the cover can be gild to upper portion of the mobile phone.

However, the above-mentioned gliding structure for the glide-open type mobile phones still suffers some drawbacks. The gliding structure does not contain turning mechanism such that the turning point of the cover is uncertain due to abrasive of resilience. It will result in the stagnancy of the cover at middle of mobile phone, which is inconvenient for user and the gliding structure for the glide-open type mobile phone does not have turning effect.

### SUMMARY OF THE INVENTION

The present invention is to provide an improved gliding structure for the glide-open type mobile phone whose envelope has smooth turning and has ideal opening and closing operability.

Accordingly, the present invention provides a gliding structure for the glide-open type mobile phone arranged between a case and an envelope of a mobile phone. The gliding structure includes a bottom plate member, an upper cap and an elastic member. The bottom plate member includes a guiding section and a turning section on inner side of the guiding section. The upper cap includes a sliding section and a directing section, wherein the sliding section is slidably fit with the guiding section of the bottom plate member and the directing section is arranged corresponding to the turning section, the directing section is moved in a direction non-parallel to a direction of the sliding section. The elastic member is arranged between the bottom plate member and the upper cap and includes two ends connected to the bottom plate member and slidable inward within the directing section, respectively.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of the first preferred embodiment of the present invention.

FIG. 2 is a perspective view of the first preferred embodiment of the present invention.

FIG. 3 is a sectional view of the first preferred embodiment of the present invention.

FIG. 4 is a schematic diagram of the present invention applied to a mobile phone.

FIG. 5 is a view showing the present invention applied to a mobile phone.

FIG. 6 is another view showing the present invention applied to a mobile phone.

FIG. 7 is a sectional view of the second preferred embodiment of the present invention.

FIG. 8 is a sectional view of the third preferred embodiment of the present invention.

FIG. 9 is another sectional view of the third preferred embodiment of the present invention.

### DETAILED DESCRIPTION OF THE INVENTION

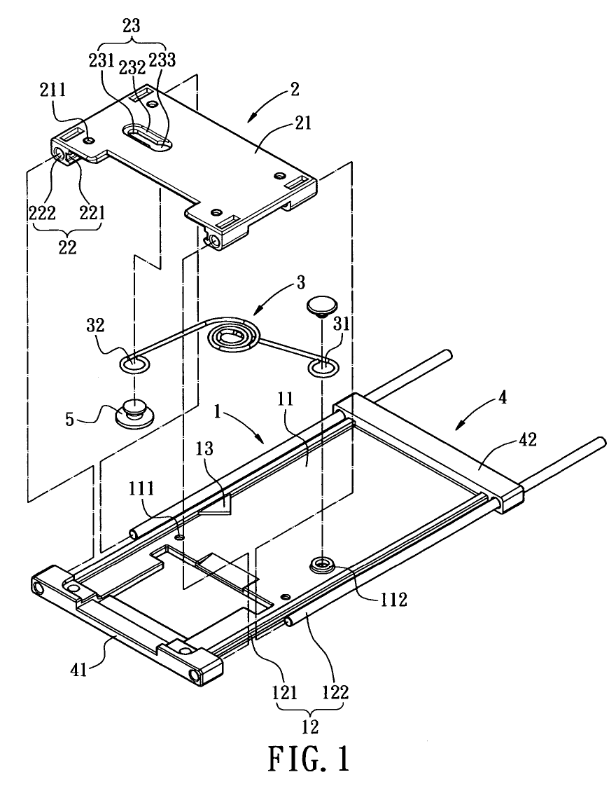

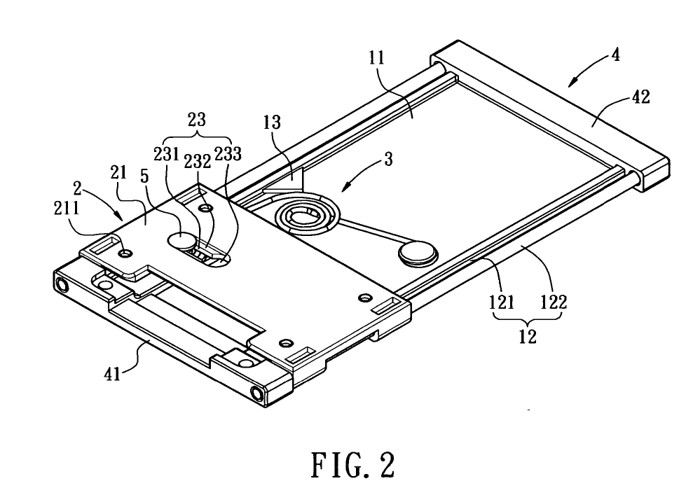

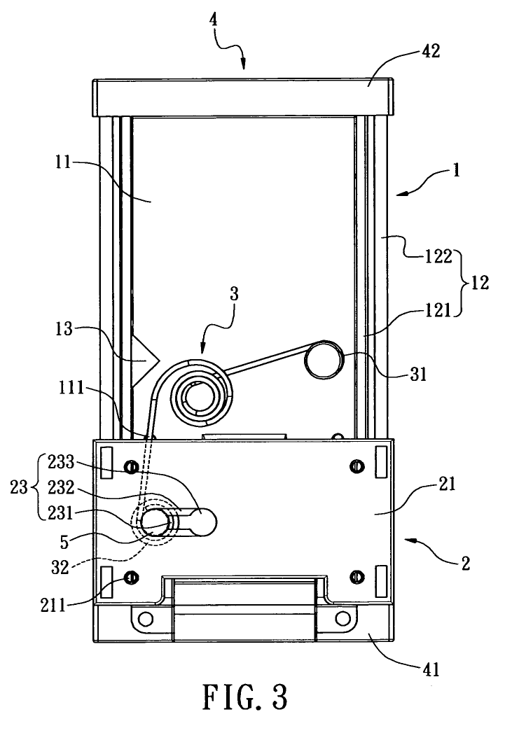

With reference to FIGS. 1, 2 and 3, the improved gliding structure for the glide-open type mobile phone mainly comprises a bottom plate member 1, an upper cap 2 and an elastic member 3.

The bottom plate member 1 comprises a bottom plate 11, a guiding section 12 and a turning section 13. The bottom plate 11 comprises a plurality of retaining holes 111 and a post 112 with threaded hole. The guiding section 12 comprises guiding rails 121 directly formed on left and right sides of the bottom plate 11, or comprises guiding rail 121 and guiding post 122 on outer side of the guiding rail 121. In the shown preferred embodiment, the guiding section 12 comprises guiding rail 121 and the guiding post 122 to enhance stability thereof. The turning section 13 is bump extended upward and formed on inner side of the guiding rail 121. The bump can be of rectangular, semi-circular, triangular or other shapes. In the preferred embodiment, the bump is of triangular shape.

The upper cap 2 is arranged on one side of the bottom plate member 1 and comprises a lid 21, a sliding section 22 and a directing section 23. The lid 21 comprises a plurality of retaining holes 211. The sliding section 22 is slid corresponding to the guiding section 12 and is implemented by sliding grooves 221 defined on left and right sides of the lid 21 or by sliding grooves 221 and through holes 222 on outer side of the sliding grooves 221. The sliding grooves 221 and the through holes 222 are mate with the guiding rail 121 and the guiding post 122 respectively to slide the upper cap 2 on the bottom plate member 1. The directing section 23 is corresponding to the turning section 13 and can be a through groove defined on the lid 21, wherein the guiding direction of the through groove is not parallel to the guiding direction of the sliding section 22. In the preferred embodiment, those guiding directions are vertical to each other. The through groove of the directing section 23 comprises a first channel 231, a second channel 232 with larger width than that of the first channel 231 and formed on outer peripheral of the first channel 231, and a rounded hole 233 defined at end of the first channel 231 and the second channel 232.

The elastic member 3 is provided between the bottom plate member 1 and the upper cap 2. In the preferred embodiment, the elastic member 3 is implemented by single torque spring and comprises a first connection end 31 and a second connection end 32 on both ends thereof. The first connection end 31 is fixed on the bottom plate member 1 while the second connection end 32 is inward slidable on the directing section 23.

The improved gliding structure for the glide-open type mobile phone further comprises a clamping mechanism 4 directly formed on the bottom plate 11 and fit on the bottom plate 11. The clamping mechanism 4 according to a preferred embodiment comprises a front baffle 41 and a rear baffle 42, wherein the front baffle 41 is integrally formed with the bottom plate 11 and the rear baffle 42 is connected to rear end of the bottom plate 11 to limit the stroke of the upper cap on the front and rear distal ends.

During assembling, the second connection end 32 of the elastic member 3 is fit on a wheel 5 and the wheel 5 is placed into the rounded hole 233 by top end thereof and slid along the first channel 231. The sliding groove 221 of the sliding section 22 is fit to the guiding rail 121 of the bottom plate 11. The lid 21 is pushed toward front end of the bottom plate 11; and the guiding post 122 and the rear baffle 42 are fit to rear end of the bottom plate 11. The guiding post 122 passes through the through hole 222 for fixing to the front baffle 41. The first connection end 31 is fit to the post 112 and then fixed to the bottom plate 11 by screw.

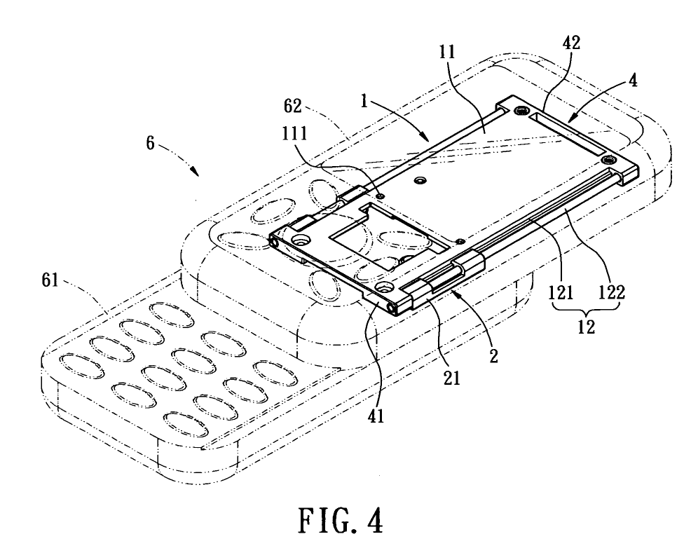

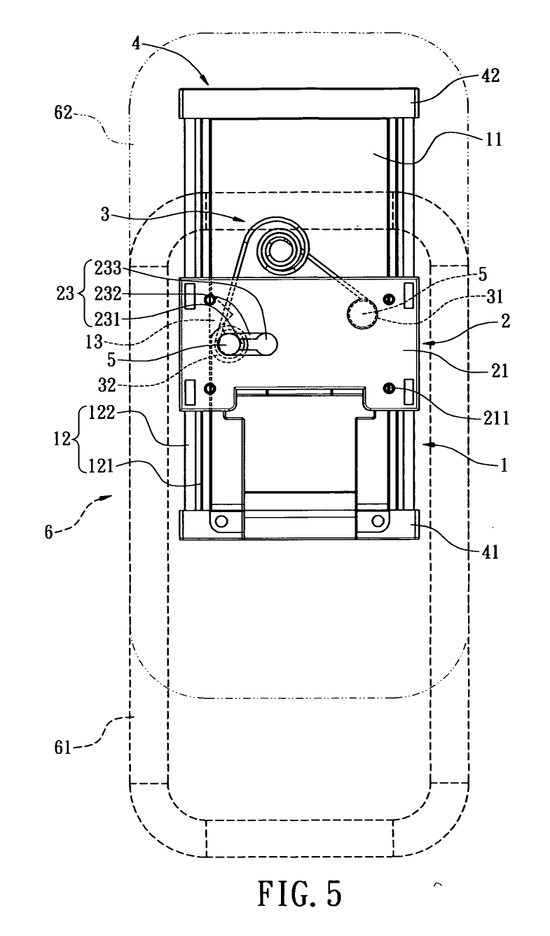

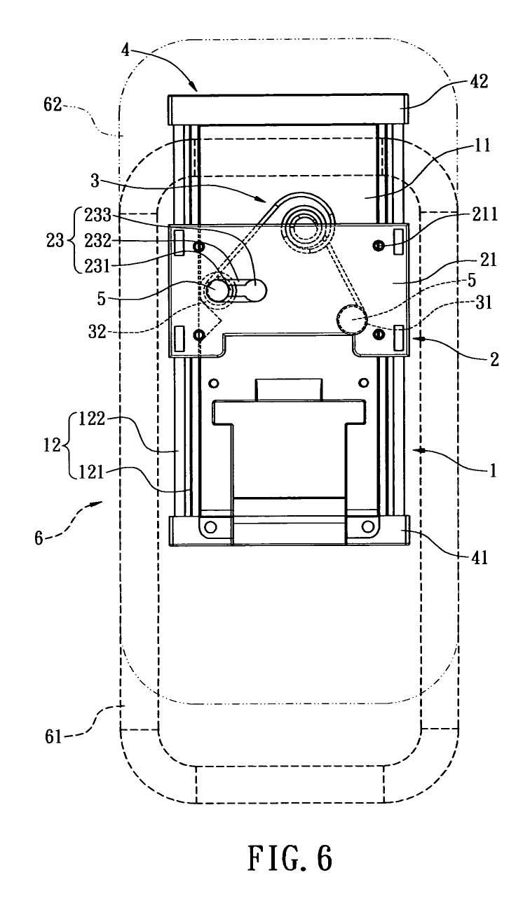

With reference to FIGS. 4, 5, and 6, the improved gliding structure for the glide-open type mobile phone can be applied to a mobile phone 6. The mobile phone 6 comprises a case 61 and an envelope 62 arranged on the case 61. The bottom plate 11 of the bottom plate member 1 is fixed to the case 61 of the mobile phone by fixing element such as screw. When the envelope 62 is pushed downward, the upper cap 2 is moved upward. The bottom edge of the wheel 5 is in contact with the directing section 23 and moved upward along the ramp of the turning section 13. The second connection end 32 of the elastic member 3 is moved inward along the directing section 23 and the moving direction is vertical to the moving direction of the upped cap 2 on the bottom plate member 1. When the envelope 62 is further pushed upward slightly, the wheel 5 moves across the apex of the turning section 13 and moves along a downward ramp of the turning section 13 to prevent the non-smooth turning of the envelope 62 and to increase the operability for opening and closing the envelope 62. The clamping mechanism 4 is provided to limit the stroke for the case 61 and the envelope 62 and to prevent the case 61 and the envelope 62 beyond the upper and lower dead points of the elastic member 3.

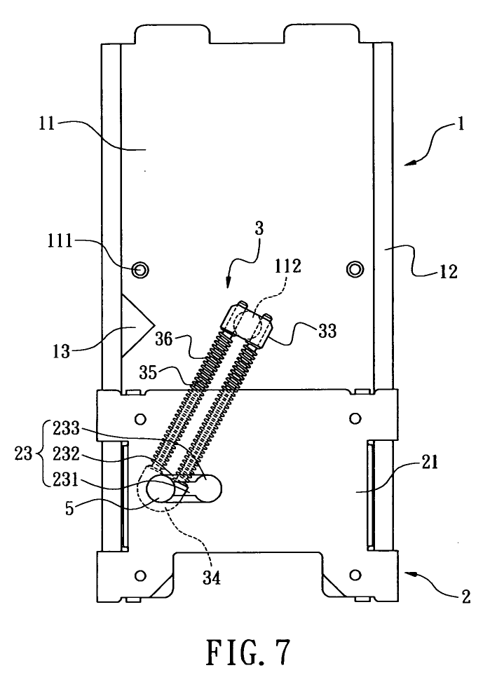

FIG. 7 shows a sectional view of the second preferred embodiment of the present invention. The elastic member 3 comprises a fixed stage 33, a moving stage 34, two shafts 35 passing the fixed stage 33 and the moving stage 34 and two compressed springs 36 arranged outside the shafts 35 and between the fixed stage 33 and the moving stage 34. The fixed stage 33 is pivotally connected to the post 112 and the moving stage 34 is fit to the wheel 5. When the upper cap 2 moves atop the bottom plate member 1 for a predetermined distance, the bottom of the wheel 5 moves along peripheral of the turning section 13 and the top of the wheel 5 moves inward along the directing section 23 such that the elastic member 3 stores energy by the compression thereof. When the wheel 5 moves across the apex of the turning section 13, the wheel 5 smoothly moves downward along the downward ramp of the turning section 13, thus opening and closing the envelope 62.

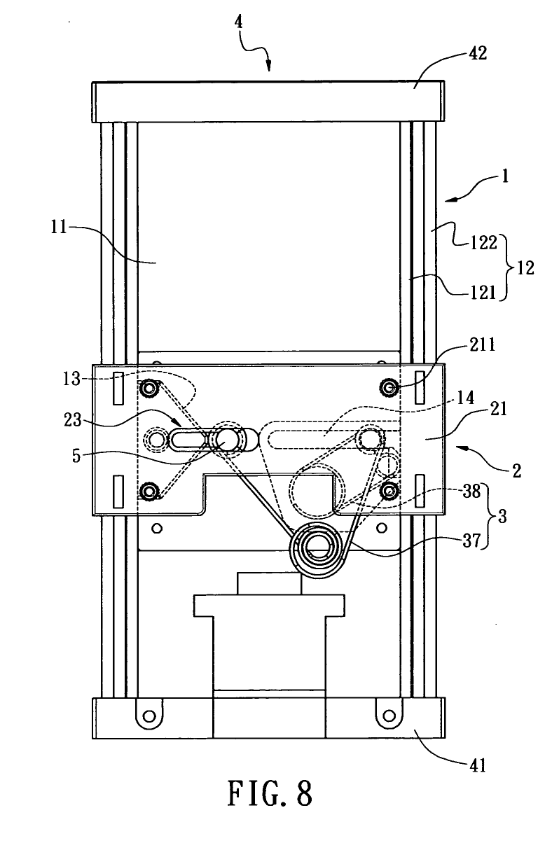

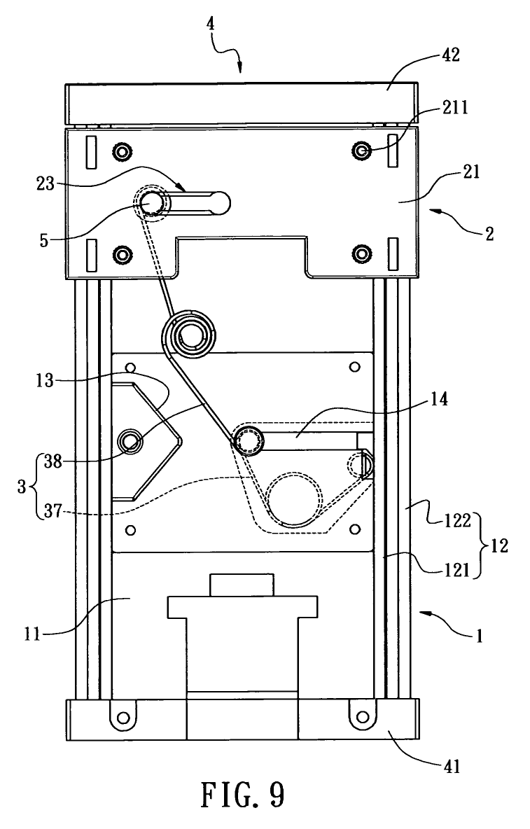

FIGS. 8 and 9 show the third preferred embodiment of the third preferred embodiment of the present invention. The elastic member 3 comprises a first spring 37 and a second spring 38 connected to one end of the first spring 37 through a connection shaft Another end of the first spring 37 is slid within the directing section 23 of the upper cap. Another end of the second spring 38 is pivotally connected to the bottom plate member 1. The bottom plate member 1 comprises a guiding groove 14 corresponding to the turning section 13, which is functioned to slide the connection shaft of the first spring 37 and the second spring 38. During operation, the upper cap 2 is pushed upward to a middle position such that one end of the first spring 37 connected to the wheel 5 is slid inward along the turning section 13. The connection shaft of the first spring 37 and the second spring 38 is slid outward along the guiding groove 14 to enhance the deformation ability of the elastic member 3 and the lifetime thereof.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A gliding structure for a glide-open type mobile phone, the gliding structure comprising
a bottom plate member comprising a guiding section and a turning section on an inner side of the guiding section;
an upper cap arranged on one side of the bottom plate member and comprising a sliding section and a directing section, wherein the sliding section is slidably fit with the guiding section and the directing section is arranged corresponding to the turning section, the directing section is moved in a direction non-parallel to a direction of the sliding section; and
an elastic member arranged between the bottom plate member and the upper cap and comprising one end connected to the bottom plate member and the other end slidable with respect within the directing section.

2. The gliding structure as in claim 1, wherein the turning section is arranged at the center of a stroke of the guiding section.

3. The gliding structure as in claim 1, wherein the bottom plate member comprises a bottom plate and the turning section is a bump extended upward and formed on an inner side of the guiding section.

4. The gliding structure as in claim 3, wherein the bump is of rectangular, semi-circular, or triangular shape.

5. The gliding structure as in claim 1, wherein the upper cap comprises a lid and the directing section is a through groove defined on the lid, the through groove guiding a direction vertical to a guiding direction of the sliding section.

6. The gliding structure as in claim 5, wherein the through groove comprises a first channel, a second channel with larger width than that of the first channel and formed on outer peripheral of the first channel, and a rounded hole defined at end of the first channel and the second channel.

7. The gliding structure as in claim 1, wherein the elastic member is a torque spring.

8. The gliding structure as in claim 1, wherein the elastic member comprises a fixed stage, a moving stage, two shafts passing the fixed stage and the moving stage and two compressed springs arranged outside the shafts and between the fixed stage and the moving stage, wherein the fixed stage is pivotally connected to the bottom plate member and the moving stage is slid within the directing section.

9. The gliding structure as in claim 1, wherein the elastic member comprises a first spring and a second spring connected to one end of the first spring through a connection shaft, the other end of the first spring being slid within the directing section, the other end of the second spring being pivotally connected to the bottom plate member which comprises a guiding groove with the connection shaft and the second spring slid therein.

10. The gliding structure as in claim 9, wherein the guiding groove is corresponding to the turning section.

11. The gliding structure as in claim 2, further comprising a clamping mechanism arranged on the bottom plate member and between two distal ends of the stroke.

12. The gliding structure as in claim 11, wherein the clamping mechanism comprises a front baffle formed with a bottom plate member and a rear baffle connected to the bottom plate member.
